(19) United States
(12) Patent Application Publication
(10) Pub. No.: US 2009/0187591 A1
(43) Pub. Date: Jul. 23, 2009

(54) Retrieving database records for aggregation without redundant database read operations

(75) Inventors: Michael Mohr, Stittsville (CA); Daniel Pietraru, Ottawa (CA)

Correspondence Address: Kramer & Amado, P.C., 1725 Duke Street, Suite 240, Alexandria, VA, 22314, US

(73) Assignee: ALCATEL LUCENT, Paris (FR)

(21) Appl. No.: 12/010,137

(22) Filed: Jan. 22, 2008

(51) Int. Cl. G06F 17/30

(52) U.S. Cl. 707/103 R; 707/E17.045

(57) ABSTRACT

Various exemplary embodiments are a computer-readable medium encoded with a database, a system including a database, and a related method including one or more of the following: a plurality of tables, each table configured to store a respective data set comprising at least one row of data and each table associated with a respective unique counter type of a plurality of unique counter types, wherein the respective unique counter type substitutes for an entry shared by each row of data in the respective data set; determining a counter from a set of data stored in the database; generating a plurality of tables; and inserting at least one row from the set of data into each table of the plurality of tables.

### BACKGROUND OF THE INVENTION

1. Field of the Invention

This invention relates generally to computer databases.

2. Description of Related Art

A computer database is a structured collection of records or data that is stored in a computer system. One type of computer database is the relational database, which organizes the records or data based on predicate logic and set theory. Relational databases include a number of tables, where each table contains rows and columns storing data. By using fields in each table to link tables to one another, the relational database model reduces redundancy, while providing the ability to execute complex queries.

Although relational databases are in many ways more powerful than so-called “flat” databases, relational databases impose additional costs. For example, when a user submits an aggregate query, the database management system (DBMS) must group sets of data determine the results. In other words, the DBMS must access the table, gather data from the table, combine the data according to the user's query, and display the results to the user. In current systems, this process results in duplication of input and output (I/O) from the database, thereby degrading system performance. Thus, there is a need for a method and system for performing more efficient aggregate calculations in relational databases, while preserving reporting speeds.

The foregoing objects and advantages of the invention are illustrative of those that can be achieved by the various exemplary embodiments and are not intended to be exhaustive or limiting of the possible advantages which can be realized. Thus, these and other objects and advantages of the various exemplary embodiments will be apparent from the description herein or can be learned from practicing the various exemplary embodiments, both as embodied herein or as modified in view of any variation which may be apparent to those skilled in the art. Accordingly, the present invention resides in the novel methods, arrangements, combinations and improvements herein shown and described in various exemplary embodiments.

### SUMMARY OF THE INVENTION

In current systems, sets of counters, counter owners, and counter values are contained within a single table in a relational database. Accordingly, each set consisting of a counter, counter owner, and counter value corresponds to a single row in the table. Because storage of the table at the database level involves the grouping of rows into I/O block, rows associated with the same counter may be stored in different I/O blocks. Accordingly, in current systems, when attempting to query for a single row, the appropriate I/O block will be retrieved, often resulting in the retrieval of rows that are unnecessary to satisfy the request. Moreover, when performing aggregate calculations, current systems perform multiple I/O block reads. Again, because not all rows from the I/O blocks are required, many unnecessary reads are performed. Because each read operation from an I/O block in the database requires computational resources, current systems introduce inefficiencies that cause significant decreases in performance when the database contains a large amount of data.

In light of the present need for more efficient aggregate calculations in a relational database, a brief summary of various exemplary embodiments is presented. Some simplifications and omission may be made in the following summary, which is intended to highlight and introduce some aspects of the various exemplary embodiments, but not to limit its scope. Detailed descriptions of a preferred exemplary embodiment adequate to allow those of ordinary skill in the art to make and use the invention concepts will follow in later sections.

According to the forgoing, various exemplary embodiments organize the data stored in a relational database to facilitate faster aggregate calculations and provide a reduction in duplicate I/O operations. Furthermore, various exemplary embodiments provide these benefits while avoiding a decrease in reporting speeds.

In various exemplary embodiments, a database is arranged such that each table in the database is associated with a counter type. Accordingly, because only one type of counter is contained within each table, the database does not need to store the type of counter in each row. In various exemplary embodiments, a label is associated with each table to indicate the counter type shared by all rows in the table. Thus, in various exemplary embodiments, the label is embedded into the name of the table.

In various exemplary embodiments, a method for arranging a database identifies an appropriate counter, generates a separate table for each counter type, and inserts data into each of the generated tables. Furthermore, in various exemplary embodiments, a method for amalgamating data accesses all tables in the database, inserts the counter type of given table into each row read from the table, and combines all rows to form an amalgamated view.

### BRIEF DESCRIPTION OF THE DRAWINGS

In order to better understand various exemplary embodiments, reference is made to the accompanying drawings, wherein:

FIG. 1 is an exploded schematic diagram of an embodiment of a system for storing data in a relational database;

FIG. 2 is a schematic diagram of an exemplary embodiment of a table stored in a relational database;

FIG. 3 is an exploded schematic diagram of an arrangement of data in an embodiment of a system for storing data from the table of FIG. 2 in a relational database;

FIG. 4 is a schematic diagram of an exemplary embodiment of a table of aggregated data calculated from entries in the database of FIG. 3;

FIG. 5 is an exploded schematic diagram of an exemplary embodiment of a system for storing data in a relational database;

FIG. 6 is an exploded schematic diagram of an exemplary embodiment of a system for storing data from the table of FIG. 2 in a relational database;

FIG. 7 is a flow chart of an exemplary embodiment of a method for efficiently arranging data in a relational database;

FIG. 8 is a flow chart of an exemplary embodiment of a method for efficiently generating an amalgamation view of a relational database; and

FIG. 9 is a schematic diagram of an exemplary table of an amalgamation view generated from data in the tables of FIG. 6.

### DETAILED DESCRIPTION OF THE PREFERRED EMBODIMENTS OF THE INVENTION

Referring now to the drawings, in which like numerals refer to like components or steps, there are disclosed broad aspects of various exemplary embodiments.

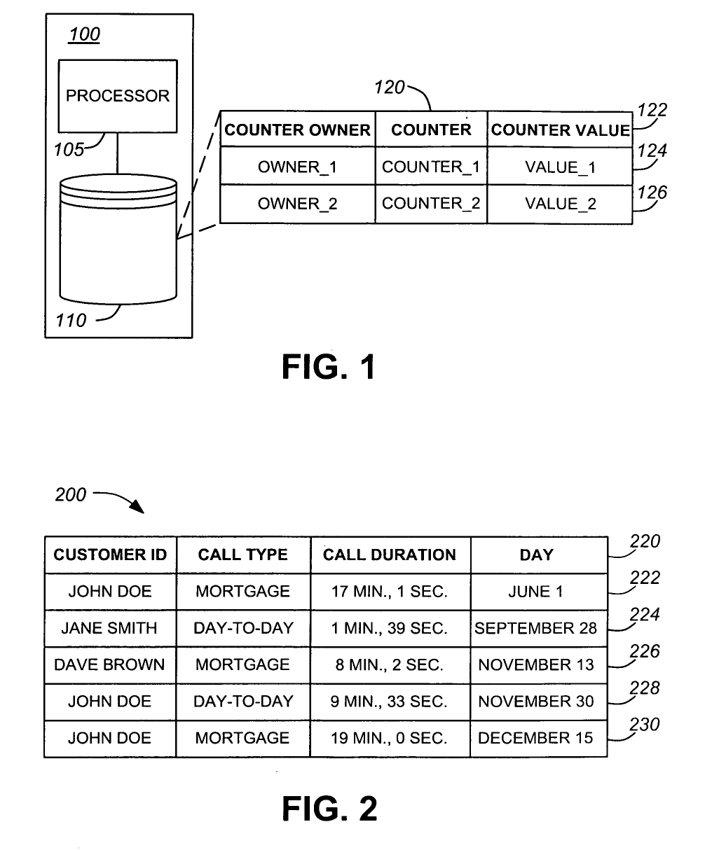

FIG. 1 is an exploded schematic diagram of an embodiment of a system 100 for storing data in a relational database. Exemplary system 100 includes processor 105, database 110, table 120, and rows 122, 124, 126.

In various exemplary embodiments, processor 105 is a computer processing unit (CPU) capable of executing computer programs and instructions. Thus, in various exemplary embodiments, processor 105 receives read and write requests and executes these requests by accessing database 110. It should be apparent that for the sake of simplicity, system 100 is shown as including only a processor 105 and database 110. Thus, in various exemplary embodiments, system 100 includes other components necessary for implementation of a database management system, including hardware controllers, memory, input/output devices, and other components apparent to those of skill in the art.

In various exemplary embodiments, database 110 is a computer storage medium that maintains a structured collection of records or data. Thus, in various exemplary embodiments, database 110 comprises a number of I/O blocks, where each I/O block is a portion of disk space used to store data for a particular table. In various exemplary embodiments, an I/O block is the smallest amount of data that may be read from database 110 in response to an access request.

In various exemplary embodiments, table 120 is a database construct storing data in a tabular fashion. Thus, in various exemplary embodiments, table 120 is comprised of rows 122, 124, 126 and columns. In various exemplary embodiments, a row is a set of data describing a single instance of a concept, while a column is a type of data used to describe a concept. For example, a row could describe an employee in a corporation, while a column used to describe the employee could contain the employee's last name. Thus, the set of columns used to create a row provides a complete description of what is being modeled within table 120.

Table 120 stores a set of counters, counter owners, and counter values in a single table. Thus, exemplary system 100 processes user queries by accessing a single table construct. Each row of table 120 comprises a set including a counter, counter owner, and counter value.

Thus, as illustrated in FIG. 1, table 120 includes row 122, which stores the column labels “Counter Owner,” “Counter,” and “Counter Value.” In various exemplary embodiments, a counter is an attribute that categorizes a set of data according to one or more counter types, a counter owner is the owner of a particular counter, and a counter value is the value of the counter. Thus, in various exemplary embodiments, a counter type is a value of a particular attribute or counter that classifies or describes the set of data.

Thus, table 120 includes a counter and two corresponding counter types, “Counter_1,” located in column 2 of row 124, and “Counter_2,” located in column 2 of row 126. “Counter 1” has an associated counter owner, “Owner_1,” located in column 1 of row 124, and an associated counter value, “Value_1”, located in column 3 of row 124. “Counter_2” has an associated counter owner, “Owner_2,” located in column 1 of row 126, and an associated counter value, “Value_2”, located in column 3 of row 126.

FIG. 2 is a schematic diagram of an exemplary embodiment of a table 200 stored in a relational database. Table 200 models an example domain in which an entity such as a financial services company desires to tally the number of service calls each customer places during a given year. For example, if the company provides multiple services to its customers, it may require aggregate calculations describing the total duration of each type of service call. In the following example, the financial services company provides two services to customers, mortgages and day-to-day banking. It should be noted that, in table 200, all data is contained within a single table.

In table 200, row 220 contains the column labels for the counter, counter owner, and counter value. The counter, “Call Type,” is located in column 2 and indicates whether the subject call was provided regarding one of two counter types, mortgages and day-to-day banking. The counter owner, “Customer ID,” is located in column 1 and indicates the customer who placed the call. It should be apparent from this example that use of the term “owner” in connection with the term “counter owner” is not intended to imply that the owner is the entity maintaining the database. The counter values, “Call Duration” and “Day,” are located in columns 3 and 4 and indicate the length of the call and the date of the call.

Accordingly, row 222 of table 200 indicates that, on June 1, John Doe placed a call related to mortgages that lasted 17 minutes and 1 second. Row 224 of table 200 indicates that, on September 28, Jane Smith placed a call related to day-to-day banking that lasted 1 minute and 39 seconds. Row 226 of table 200 indicates that, on November 13, Dave Brown placed a call related to mortgages that lasted 8 minutes and 2 seconds. Row 228 of table 200 indicates that, on November 30, John Doe placed a call related to day-to-day banking that lasted 9 minutes and 33 seconds. Finally, row 230 of table 200 indicates that, on December 15, John Doe placed a call related to mortgages that lasted 19 minutes.

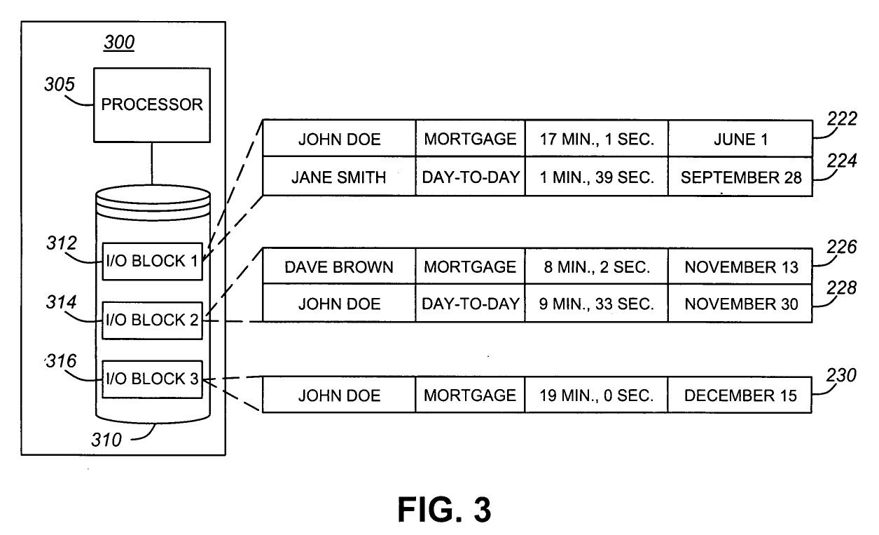

FIG. 3 is an exploded schematic diagram of an arrangement of data in an embodiment of a system 300 for storing data from table 200 of FIG. 2 in a relational database. System 300 includes components suitable for storing the data contained in table 200 of FIG. 2. Thus, system 300 includes processor 305, database 310, I/O block 1 312, 1/O block 2 314, I/O block 3 316, and rows 222, 224, 226, 228, 230. It should be apparent that, in various exemplary embodiments, processor 305 is similar in functionality to processor 105, while database 310 is similar in functionality to database 110.

In various exemplary embodiments, database 310 comprises a number of I/O blocks including I/O block 1 312, I/O block 2 314, and I/O block 3 316. To maximize efficiency of read and write operations, each I/O block 312, 314, 316 is capable of storing multiple rows of data. Thus, I/O block 1 312 stores rows 222, 224, 10 block 2 314 stores rows 226, 228, and I/O block 3 326 stores row 230. Accordingly, when a user submits a query for a single row of data, database 310 may be required to read multiple rows of data from an I/O block 312, 314, 316 to return the correct result.

Although each I/O block 312, 314, 316 is capable of storing two rows of data, in various exemplary embodiments, each I/O block 312, 314, 316 is capable of storing more than two rows of data. In addition, in various exemplary embodiments, database 310 includes any positive integer number of I/O blocks.

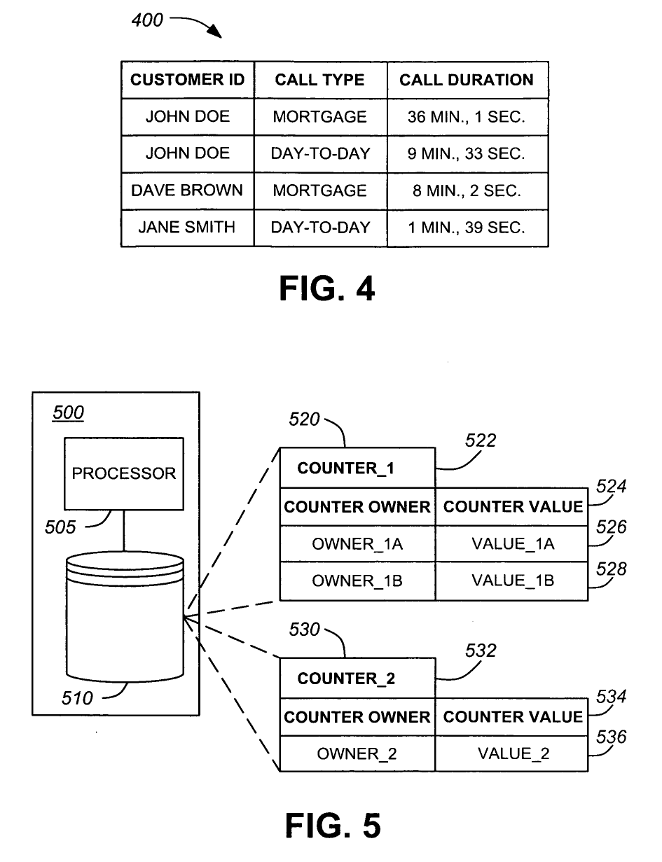

FIG. 4 is a schematic diagram of an exemplary embodiment of a table 400 of aggregated data calculated from entries in database 310 of FIG. 3. The data in table 400 is determined by performing a series of operations on the data stored in database 310 of FIG. 3.

By way of example, the data in table 400 represents the total call time per service category per customer calculated based on the data stored in database 310. Thus, table 400 indicates that John Doe's calls relating to mortgages totaled 36 minutes and 1 second, John Doe's calls related to day-to-day banking totaled 9 minutes and 33 seconds, Dave Brown's calls related to mortgages totaled 8 minutes and 2 seconds, and Jane Smith's calls related to day-to-day banking totaled 1 minute and 39 seconds. Thus, by examining the aggregated data in table 400, the company can determine that John Doe was the most active customer in terms of placing service calls.

The process for generating table 400 using the data stored in database 310 will now be described with reference to FIGS. 3 and 4. In various exemplary embodiments, system 300 uses two approaches to generate the data contained in table 400. In one embodiment, system 300 queries database 310 by customer and then determines the total call times per service type. Alternatively, system 300 queries database 310 per service type and then tallies the call durations per customer. As will be apparent from the description below, either approach results in redundant I/O from database 310.

The second of these two aggregation approaches will now be described in detail. To determine the total call times for calls related to mortgages, system 300 first queries database 310 for all database records containing a counter type equal to “Mortgage.” Based on this query, database 310 retrieves rows 222, 226, 230 from I/O Blocks 312, 314, 316, respectively, as each of these rows contains data regarding mortgage-related calls. System 300 then calculates the total call duration for each customer using rows 222, 226, 230. Note, however, that because database 310 must read an entire I/O block at a time, database 310 will also retrieve rows 224, 228.

To determine the total call times for calls related to day-to-day banking, system 300 then queries database 310 for all database records containing a counter equal to “Day-To-Day.” Based on this query, database 310 retrieves rows 224, 228 from I/O Blocks 312, 314, respectively, as each of these rows contains data regarding day-to-day-related calls. System 300 then calculates the total call duration for each customer using rows 224, 228. Again, because database 310 must read an entire I/O block at a time, database 310 will also retrieve rows 222, 226.

As apparent from the description above, the data arrangement used in database 310 introduces inefficiencies when performing aggregation operations. More specifically, in the example described above, database 310 performs duplicate I/O on rows 222, 224, 226, 228, as each row is read during both queries. In the example given, the amount of duplicate I/O is relatively insignificant. In a typical database, which contains billions or even trillions of records, however, this duplicate I/O results in significant and, in some cases, catastrophic slowdown of the system. In various exemplary embodiments, the arrangement of data described with reference to FIGS. 5-9 prevents duplicate I/O and therefore minimizes these inefficiencies in the database.

FIG. 5 is an exploded schematic diagram of an exemplary embodiment of a system 500 for storing data in a relational database. System 500 includes processor 505, database 510, table 520, label 522, rows 524, 526, 528, table 530, label 532, and rows 534, 536. It should be apparent that, in various exemplary embodiments, processor 505 is similar in functionality to processor 105, while database 510 is similar in functionality to database 110. However, in various exemplary embodiments, the database 510 stores a separate table for each unique counter type. Because only one counter type is contained within each table, database 510 does not need to store the counter type in each row, thereby reducing the total amount of storage space required by database 510.

As illustrated in FIG. 5, table 520 describes data related to “Counter_1,” indicated by label 522. In various exemplary embodiments, label 522 indicates that all data stored in table 520 relates to the counter type, “Counter_.” In various exemplary embodiments, label 522 is a constant, string, number, or other value indicating that table 520 stores data related to the counter type specified by label 522. Although illustrated in FIG. 5 as an entry in table 520, in various exemplary embodiments, label 522 is embedded in the table name for table 520. Thus, for example, the table name for table 520 could be “COUNTER_1_DATA_TABLE.”

Table 520 also stores row 524, which includes a column label for each column of table 520. Thus, row 524 indicates that column 1 of table 520 stores data regarding “Counter Owner,” while column 2 stores data regarding “Counter Value.” In various exemplary embodiments, rows 526, 528 store the data associated with “Counter_1.” Thus, row 526 stores “Owner_1a” in the “Counter Owner” field and “Value_1 a” in the “Counter Value” field. Row 528 stores “Owner_1b” in the “Counter Owner” field and “Value_1b” in the “Counter Value” field.

Table 530 describes data related to the counter type “Counter_2,” indicated by label 532. In various exemplary embodiments, label 532 is similar in functionality to label 522. Table 530 also stores row 534, which includes a column label for each column of table 530. Thus, row 534 indicates that column 1 of table 530 stores data regarding “Counter Owner,” while column 2 stores data regarding “Counter Value.” In various exemplary embodiments, row 536 stores the data associated with “Counter_2.” Thus, row 536 stores “Owner_2” in the “Counter Owner” field and “Value_2” in the “Counter Value” field. It should be apparent that although illustrated with two counter types and corresponding tables 520, 530, in various exemplary embodiments, database 510 stores any positive integer number of counter types and corresponding tables.

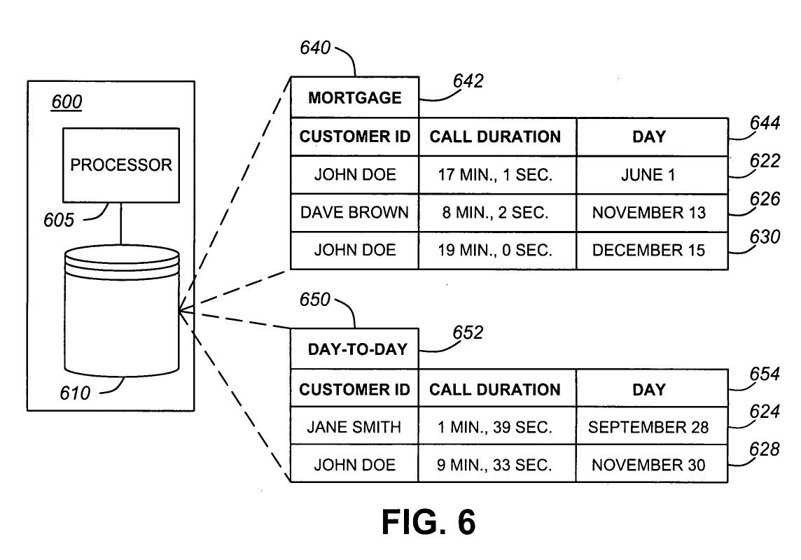

FIG. 6 is an exploded schematic diagram of an exemplary embodiment of a system 600 for storing data from table 200 of FIG. 2 in a relational database 610. System 600 includes components suitable for storing the data contained in table 200, of FIG. 2. Thus, system 600 includes processor 605, database 610, rows 622, 624, 626, 628, 630, table 640, label 642, row 644, table 650, label 652, and row 654. It should be apparent that, in various exemplary embodiments, processor 605 is similar in functionality to processor 505, while database 610 is similar in functionality to database 510.

Returning now to the example of an entity such as a financial services company, tables 640, 650 store information related to the number of service calls each customer places during a given year. It should be noted that, in contrast to table 200 illustrated in FIG. 2, the data is divided into a separate table for each call type. Table 640 stores data for mortgage-related calls, as indicated by label 642. Accordingly, table 640 stores data from rows 222, 226, 230 of table 200 in rows 622, 626, 630, respectively, but omits the column from table 200 having the shared counter type, “Mortgage,” as this value is maintained in label 642. Thus, row 644 stores column labels, but does not include a column label for “Call Type.”

Table 650 stores data for calls related to day-to-day banking, as indicated by label 652. Accordingly, table 650 stores data from rows 224, 228 of table 200 in rows 624, 628, respectively, but omits the column from table 200 having the shared counter type, “Day-To-Day,” as this value is maintained in label 652. Thus, row 654 stores column labels, but does not include a column label for “Call Type.”

In various exemplary embodiments, using the arrangement of data shown in exemplary database 610 simplifies the aggregation calculation. When determining the total duration of mortgage-related calls per customer, database 610 need only access table 640, thereby eliminating access to day-to-day related data. Similarly, when determining the total duration of calls related to day-to-day banking, database 610 need only access table 650, thereby eliminating access to mortgage-related data. The results of each determination can then be combined to form the aggregated data contained in table 400, illustrated in FIG. 4. Accordingly, this arrangement of data simplifies the calculation required to obtain aggregate data, while completely eliminating redundant I/O.

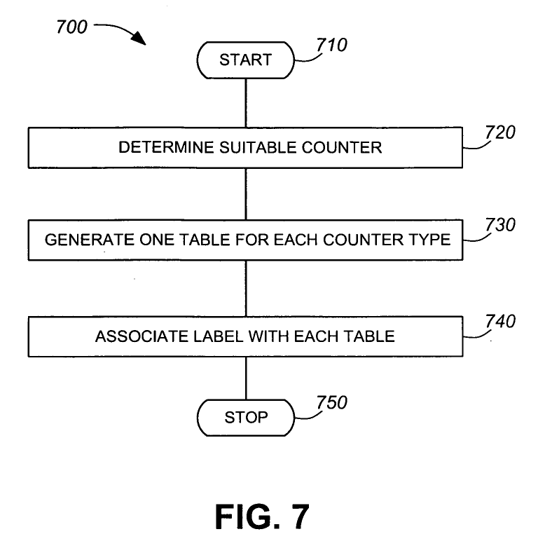

FIG. 7 is a flow chart of an exemplary embodiment of a method 700 for efficiently arranging data in a relational database. In various exemplary embodiments, given a set of data or an existing database, exemplary method 700 generates a database arranged for efficient aggregation calculations.

Exemplary method 700 starts in step 710 and proceeds to step 720, where a suitable counter is determined. In various exemplary embodiments, this determination is based on an analysis of the data contained in the existing set of data. In various exemplary embodiments, a user specifies the desired counter or indicates which column of data should serve as the counter.

After determining a suitable counter in step 720, exemplary method 700 proceeds to step 730, where a separate table is generated for each counter type and the data is inserted into the table, excluding the counter type. In various exemplary embodiments, the data for the specified counter is analyzed to determine the number of distinct counter types. Alternatively, the user specifies the total number of counter types and their associated labels. Accordingly, in various exemplary embodiments, the number of tables generated in step 730 equals the total number of distinct counter types.

After generating the tables in step 730, exemplary method 700 then proceeds to step 740, where a label is associated with each table based on the counter type. In various exemplary embodiments, the label is a constant, string, number, or other value indicating that table stores data related to the counter type. In various exemplary embodiments, the label is embedded in the table name. Exemplary method 700 then proceeds to step 750, where exemplary method 700 stops.

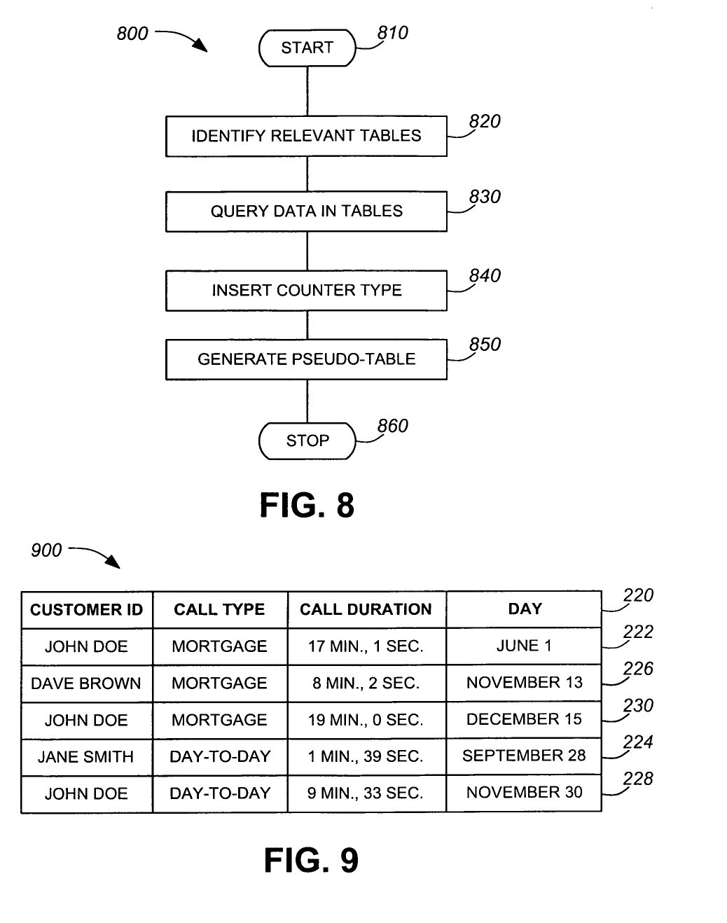

FIG. 8 is a flow chart of an exemplary embodiment of a method 800 for efficiently generating an amalgamation view of a relational database. In various exemplary embodiments, exemplary method 800 accesses a database containing one table for each counter type to generate a single pseudo-table that appears to store all data. In various exemplary embodiments, this pseudo-table is generated through the use of a view query, which provides one or more columns from a specified table or produces a superset of data by combining the data from two or more tables.

Exemplary method 800 starts in step 810 and proceeds to step 820, where the relevant tables for generating the pseudo-table are identified. Thus, in various exemplary embodiments, a database is accessed to identify all tables and the corresponding label for each table. Exemplary method 800 then proceeds to step 830, where the data in each table is queried. Thus, in various exemplary embodiments, one or more columns of data are retrieved from each table including the counter owner and/or one or more counter values.

After performing the data query in step 830, exemplary method 800 proceeds to step 840, where the corresponding counter type is inserted into the results read from the table. Thus, in various exemplary embodiments, a column is inserted into the result set, with each entry in the column set to the label for the table. Thus, in various exemplary embodiments, each entry in the column is a constant, string, number, or other value.

Exemplary method 800 then proceeds to step 850, where the pseudo-table is generated by combining the results of the previous operations. In various exemplary embodiments, a heading for the pseudo-table is created to indicate the contents of each column. Each retrieved table, including the counter type column, is added in its entirety to the pseudo-table, thereby generating an amalgamation view of all data in the database. In addition, in various exemplary embodiments, the pseudo-table is displayed to the requesting user. Exemplary method 800 then proceeds to step 860, where exemplary method 800 stops.

FIG. 9 is a schematic diagram of an exemplary table 900 of an amalgamation view generated from data in tables 640, 650 of FIG. 6 in accordance with exemplary method 800. Thus, given the data stored in tables 640, 650 of FIG. 6, exemplary method 800 generates an amalgamation view displaying all data represented in tables 640, 650.

As illustrated, the amalgamation view includes a row 220, which contains headings indicating the contents of each column in table 900. Rows 222, 226, 230 are generated by combining the data contained in rows 622, 626, 630, respectively, with label 642. Rows 224, 228 are generated by combining the data contained in rows 624, 628, respectively, with label 654. Accordingly, table 900 provides a single amalgamated view of all data stored in database 610.

In the preceding description of FIGS. 1-9, it should be apparent that, in various exemplary embodiments, tables 120, 200, 400, 520, 530, 640, 650, 900 include nearly any different number of rows and/or columns according to nearly infinite possibilities of combinations. Moreover, in various exemplary embodiments, the counter value in each table comprises multiple fields spanning two or more columns.

According to the forgoing, various exemplary embodiments arrange a database such that data associated with each counter type is stored in a separate table. Thus, various exemplary embodiments minimize redundant I/O, thereby providing efficient querying speeds when calculating aggregate values based on data contained in the database. In addition, various exemplary embodiments eliminate the need to store a counter type for each entry in the database, thereby decreasing the amount of storage required by the database.

Although the various exemplary embodiments have been described in detail with particular reference to certain exemplary aspects thereof, it should be understood that the invention is capable of other different embodiments, and its details are capable of modifications in various obvious respects. As is readily apparent to those skilled in the art, variations and modifications can be affected while remaining within the spirit and scope of the invention. Accordingly, the foregoing disclosure, description, and figures are for illustrative purposes only, and do not in any way limit the invention, which is defined only by the claims.

What is claimed is:

1. A computer-readable medium encoded with a database structure, the database structure comprising:
a plurality of tables, each table configured to store a respective data set comprising at least one row of data and each table associated with a respective unique counter type of a plurality of unique counter types,
wherein the respective unique counter type substitutes for an entry shared by each row of data in the respective data set.

2. The computer-readable medium encoded with a database structure according to claim 1, wherein the database structure is a relational database structure.

3. The computer-readable medium encoded with a database structure according to claim 1, wherein:
the database structure further comprises a plurality of labels,
each label is associated with a respective table of the plurality of tables, and
each label describes the respective unique counter type of the plurality of unique counter types.

4. The computer-readable medium encoded with a database structure according to claim 3, wherein each label is selected from the group consisting of a constant, a string, and a number.

5. The computer-readable medium encoded with a database structure according to claim 3, wherein each label is embedded in a name of the respective table of the plurality of tables.

6. The computer-readable medium encoded with a database structure according to claim 1, wherein each row of data in the respective data set comprises at least one of a counter owner and a counter value.

7. The computer-readable medium encoded with a database structure according to claim 6, wherein the counter value comprises multiple data fields.

8. A computer system including a database structure, the database structure comprising:
a plurality of tables, each table configured to store a respective data set comprising at least one row of data and each table associated with a respective unique counter type of a plurality of unique counter types,
wherein the respective unique counter type substitutes for an entry shared by each row of data in the respective data set.

9. The computer system according to claim 8, wherein the database structure is a relational database structure.

10. The computer system according to claim 8, wherein:
the database structure further comprises a plurality of labels,
each label is associated with a respective table of the plurality of tables, and
each label describes the respective unique counter type of the plurality of unique counter types.

11. The computer system according to claim 10, wherein each label is selected from the group consisting of a constant, a string, and a number.

12. The computer system according to claim 10, wherein each label is embedded in a name of the respective table of the plurality of tables.

13. The computer system according to claim 8, wherein each row of data in the respective data set comprises at least one of a counter owner and a counter value.

14. The computer system according to claim 13, wherein the counter value comprises multiple data fields.

15. A computer-implemented method of arranging data in a database, the method comprising:
determining a counter from a set of data, the counter classifying the set of data according to a plurality of unique counter types;
generating a plurality of tables in the database, each table associated with a respective unique counter type of the plurality of unique counter types; and
inserting at least one row from the set of data into a respective table of the plurality of tables, wherein the respective unique counter type substitutes for an entry shared by the at least one row.

16. The computer system according to claim 15, wherein the database is a relational database.

17. The computer system according to claim 15, further comprising associating a respective label of a plurality of labels with the respective table of the plurality of tables.

18. The computer system according to claim 17, wherein the respective label of the plurality of labels describes the respective unique counter type of the plurality of unique counter types.

19. The computer system according to claim 17, wherein the respective label of the plurality of labels is selected from the group consisting of a constant, a string, and a number.

20. The computer system according to claim 15, wherein the at least one row comprises at least one of a counter owner and a counter value.

21. The computer system according to claim 20, wherein the counter value comprises multiple data fields.

22. The computer system according to claim 15, wherein the database stores data related to customer calls to a financial services company.

23. A computer-implemented method of amalgamating entries in a database, the method comprising:
accessing a plurality of tables in the database, each table associated with a respective unique counter type of a plurality of unique counter types;
retrieving at least one row from each of the plurality of tables;
adding, to the at least one row from each of the plurality of tables, a label corresponding to the respective unique counter type of the plurality of unique counter types; and
combining the at least one row from each of the plurality of tables to form an amalgamated table.

24. The computer-implemented method of amalgamating entries in a database according to claim 23, further comprising displaying the amalgamated table to a user.

25. The computer-implemented method of amalgamating entries in a database according to claim 23, wherein the label is selected from the group consisting of a constant, a string, and a number.
